(19) United States
(12) Patent Application Publication
(10) Pub. No.: US 2021/0390466 A1
(43) Pub. Date: Dec. 16, 2021

(54) FAST, PREDICTIVE, AND ITERATION-FREE AUTOMATED MACHINE LEARNING PIPELINE

(71) Applicant: Oracle International Corporation, Redwood Shores, CA (US)

(72) Inventors: Venkatanathan Varadarajan, Seattle, WA (US); Sandeep R. Agrawal, San Jose, CA (US); Hesam Fathi Moghadam, Sunnyvale, CA (US); Anatoly Yakovlev, Hayward, CA (US); Ali Moharrer, San Jose, CA (US); Jingxiao Cai, Newark, CA (US); Sanjay Jinturkar, Santa Clara, CA (US); Nipun Agarwal, Saratoga, CA (US); Sam Idicula, Santa Clara, CA (US); Nikan Chavoshi, Redwood City, CA (US)

(21) Appl. No.: 17/086,204

(22) Filed: Oct. 30, 2020

Related U.S. Application Data
(60) Provisional application No. 63/039,348, filed on Jun. 15, 2020.

(51) Int. Cl. G06N 20/20; G06N 5/04

(52) U.S. Cl. CPC G06N 20/20; G06N 5/043

(57) ABSTRACT

A proxy-based automatic non-iterative machine learning (PANI-ML) pipeline is described, which predicts machine learning model configuration performance and outputs an automatically-configured machine learning model for a target training dataset. Techniques described herein use one or more proxy models—which implement a variety of machine learning algorithms and are pre-configured with tuned hyperparameters—to estimate relative performance of machine learning model configuration parameters at various stages of the PANI-ML pipeline. The PANI-ML pipeline implements a radically new approach of rapidly narrowing the search space for machine learning model configuration parameters by performing algorithm selection followed by algorithm-specific adaptive data reduction (i.e., row- and/or feature-wise dataset sampling), and then hyperparameter tuning. Furthermore, because of the one-pass nature of the PANI-ML pipeline and because each stage of the pipeline has convergence criteria by design, the whole PANI-ML pipeline has a novel convergence property that stops the configuration search after one pass.

### CROSS-REFERENCE TO RELATED APPLICATIONS; BENEFIT CLAIM

This application claims the benefit of Provisional Appln. 63/039,348, filed Jun. 15, 2020, the entire contents of which is hereby incorporated by reference as if fully set forth herein, under 35 U.S.C. § 119(e).

Furthermore, this application is related to the following applications, the entire contents of each of which is hereby incorporated by reference as if fully set forth herein:
U.S. application Ser. No. 15/884,163 (Attorney Ref. No. 50277-5191), titled “Algorithm-specific Neural Network Architectures for Automatic Machine Learning Model Selection”, filed Jan. 30, 2018;
U.S. application Ser. No. 15/885,515 (Attorney Ref. No. 50277-5192), titled “Gradient-based Auto-Tuning for Machine Learning and Deep Learning Models”, filed Jan. 31, 2018;
U.S. application Ser. No. 16/137,719 (Attorney Ref. No. 50277-5235), titled “Scalable and Efficient Distributed Auto-tuning of Machine Learning and Deep Learning Models”, filed Sep. 21, 2018;
U.S. application Ser. No. 16/166,039 (Attorney Ref. No. 50277-5298), titled “Mini-Machine Learning”, filed Oct. 19, 2018, titled “Mini-Machine Learning”, referred to herein as the “Mini-ML Application”;
U.S. application Ser. No. 16/384,588 (Attorney Ref. No. 50277-5380), titled “Predicting Machine Learning or Deep Learning Model Training Time”, filed Apr. 15, 2019;
U.S. application Ser. No. 16/388,830 (Attorney Ref. No. 50277-5381), titled “Using Hyperparameter Predictors to Improve Accuracy of Automatic Machine Learning Model Selection”, filed Apr. 18, 2019;
U.S. application Ser. No. 16/417,145 (Attorney Ref. No. 50277-5399), titled “Automatic Feature Subset Selection Using Feature Ranking and Scalable Automatic Search”, filed May 20, 2019;
U.S. application Ser. No. 16/426,530 (Attorney Ref. No. 50277-5459), titled “Using Metamodeling for Fast and Accurate Hyperparameter Optimization of Machine Learning and Deep Learning Models”, filed May 30, 2019;
U.S. application Ser. No. 16/547,312 (Attorney Ref. No. 50277-5460), titled “Automatic Feature Subset Selection based on Meta-Learning”, filed Aug. 21, 2019;
U.S. application Ser. No. 16/718,164 (Attorney Ref. No. 50277-5505), titled “Adaptive Sampling for Imbalance Mitigation and Dataset Size Reduction in Machine Learning”, filed Dec. 17, 2019; and
U.S. application Ser. No. 17/071,285 (Attorney Ref. No. 50277-5695), titled “Automated Machine Learning Pipeline for Time Series Datasets Utilizing Point-Based Algorithms”, filed Oct. 15, 2020.

### FIELD OF THE INVENTION

The techniques described herein relate to automatically configuring a machine learning model for a given training dataset, and, more particularly, to using proxy machine learning models to facilitate non-iterative automatic configuration of a machine learning model to fit to a given training dataset.

### BACKGROUND

The International Data Corporation predicts that, by 2025, increasing data generation rates will usher in an age of applications with rapid machine learning (ML) model build-to-use cycles. Even now, in industrial settings, the ability to quickly get results is crucial to jump start a new machine learning project. Also, deployed models often need to be retuned on fresh datasets to manage drifts between training and inference data, which can cause costly downtime for the deployed models. Without automated ML model configuration, the aid of highly-specialized data scientists is required to properly configure or recalibrate ML models. However, data science expertise is, and most likely will continue to remain, scarce. Thus, dependence on data scientists for configuring machine learning models will not be sustainable or scalable for many future applications.

Accordingly, the objective of an automated machine-learning (AutoML) pipeline is to sustain an ML model development cycle without requiring the expertise of a data scientist. Using an AutoML pipeline, a novice user with little to no background in data science can take advantage of machine learning. However, it can be difficult for an AutoML pipeline to efficiently identify a configuration for an optimal ML model for a given training dataset. Specifically, configuring an ML model for a given dataset involves selection of multiple configuration parameters, including identifying the set of rows and/or features from the dataset for training the model, selecting the best ML algorithm for the dataset, and identifying the best hyperparameters for the trained model. There are hundreds, or even thousands, of potential combinations of configuration parameters for any given dataset.

Given the number of potential ML model configurations, it is difficult to guarantee that any given model configuration is the “optimal” ML model, i.e., that the identified ML model is better than all other possible model configurations. Thus, the goal of an AutoML optimizer is to identify a “close-to-optimal” ML model that is well-suited to the target dataset when compared to a majority of the other possible model configurations explored in the given search space.

The complexity of ML model configuration is increased by the interdependence of the different configuration parameters. For example, the set of features that should be selected from a given dataset generally depends on the ML algorithm selected for the model. Also, the effectiveness of an ML model that implements a given ML algorithm is dependent on the hyperparameters selected for the model. Further, selection of hyperparameters for a model relies on training the selected ML model using a selected set of features from the training dataset.

To further complicate ML model configuration, training datasets may have any type of data, including tabular data, structured data, image data, time series data, etc. These different types of datasets require different pre-processing in order to prepare the datasets to train ML models. Also, dataset pre-processing can be optimized depending on the selected ML algorithm.

Given the large search space for ML model configuration and interdependence between configuration parameters, AutoML optimizers generally explore various ML model configuration parameter values together to effectively capture and evaluate dependencies among the parameters. Hence, AutoML optimizers are generally iterative, evaluating a large number of ML model configuration permutations by adjusting configuration parameters in order to explore the search space. Each iteration can be costly given that existing approaches generally suffer from the cold-start problem, which is an inability to predict how a model configuration will perform on a new dataset. Optimizers suffering from the cold-start problem are required to fully evaluate each new configuration for performance with the dataset in order to determine the suitability of the configuration for the dataset.

Such approaches to exploration of the search space generally require a significant amount of time (such as multiple hours or even days) to produce a reasonable solution. Furthermore, because of the complexity of the optimization problem being undertaken, existing AutoML optimizers generally do not converge even when allowed a significant amount of time to explore configuration parameters for a given dataset. Thus, such optimizers generally must be stopped by optimizer administrators after allowing them to operate for an administrator-determined amount of time. However, when such an optimizer is stopped, there is no guarantee that the resulting ML model is the best version that has been found by the optimizer, let alone being an optimal, or close-to-optimal, configuration for the target dataset. The high cost/duration of iterative evaluation makes such optimizers impractical for large datasets or for AutoML projects with short time budgets.

As such, it would be beneficial for an AutoML optimizer to automatically configure a close-to-optimal machine learning model to fit to a particular training dataset within a time budget, where the identified ML model is known to be the most optimal model configuration that was identified by the optimizer.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1 depicts a block diagram of an example computing device system running a proxy-based automatic non-iterative ML (PANI-ML) application that automatically identifies and configures an ML model to fit a target training dataset.

FIG. 2 depicts an embodiment of a PANI-ML pipeline.

FIG. 3 depicts an example ML algorithm selection block diagram.

FIG. 4 depicts an example dataset feature selection block diagram.

FIG. 5 depicts an example dataset row sampling block diagram.

FIG. 6 depicts an example asynchronous hyperparameter optimizer block diagram.

FIG. 7 depicts an example visualization of application of a gradient-based search space reduction algorithm utilized during hyperparameter selection.

FIG. 8 depicts a chart comparing average rankings of AutoML optimizers across various datasets and random seeds.

FIG. 9 depicts a comparison between performance of various AutoML optimizers with 60-minute time budgets on various datasets.

FIG. 10 depicts a chart with the runtime breakdown of stages in the PANI-ML pipeline across different test datasets of a test corpus for a 60-minute time budget.

FIG. 11 is a block diagram that illustrates a computer system upon which an embodiment may be implemented.

FIG. 12 is a block diagram of a basic software system that may be employed for controlling the operation of a computer system.

### DETAILED DESCRIPTION

In the following description, for the purposes of explanation, numerous specific details are set forth in order to provide a thorough understanding of the techniques described herein. It will be apparent, however, that the techniques described herein may be practiced without these specific details. In other data samples, well-known structures and devices are shown in block diagram form in order to avoid unnecessarily obscuring the techniques described herein.

### General Overview

Unlike iterative AutoML optimizers, techniques described herein use a proxy-based automatic non-iterative ML (PANI-ML) pipeline to predict ML model configuration performance. Techniques described herein use one or more proxy models—which implement a variety of ML algorithms and are pre-configured with tuned hyperparameters—to estimate relative performance of ML model configuration parameters at various stages of the PANI-ML pipeline. Proxy models can be used to accurately predict relative ranking between different ML model configurations because metalearning across a wide variety of datasets is used to identify the hyperparameters of each proxy model implementing a particular ML algorithm. Techniques described herein select configuration parameters for an ML model to fit a target training dataset based on the estimates generated using proxy models. Thus, proxy models are performance predictors that are used in the PANI-ML pipeline to make the pipeline iteration-free, and to solve the cold-start problem, allowing the stages of the pipeline to identify performant solutions in less time than would be required if the stages were started without the proxy models.

The PANI-ML pipeline implements a radically new approach of rapidly narrowing the search space for ML model configuration parameters by performing algorithm selection followed by algorithm-specific adaptive data reduction (i.e., row- and/or feature-wise dataset sampling), and then hyperparameter tuning. Each pipeline stage parameter selection outcome is final and only affects the downstream stages. The iteration-free nature of the PANI-ML pipeline significantly speeds up the ML model configuration process, while achieving competitive model performance relative to state-of-the-art AutoML pipelines.

The PANI-ML pipeline ensures that decisions that have greater effect on the resulting ML model configuration are made early in the pipeline. Making more-impactful decisions early on in the pipeline narrows searches performed in later stages to areas of the search space that include close-to-optimal ML model configurations without requiring an exhaustive search of the configuration parameter space. Furthermore, when acting under a time budget, prioritizing the more impactful decisions ensures that they are performed before later stages that refine the configuration in ways that are less critical to the end result.

Furthermore, because of the one-pass nature of the PANI-ML pipeline and because each stage of the pipeline has convergence criteria by design, the whole PANI-ML pipeline has a novel convergence property that stops the configuration search after one pass. Specifically, each stage of the PANI-ML pipeline is able to converge to an answer, and then the pipeline moves to the next stage based on the previous decisions. Accordingly, even without a forced time budget, the PANI-ML pipeline completes the search for a particular close-to-optimal ML model after a finite amount of time. The different stages of PANI-ML pipeline being designed to converge increases confidence in the outcomes produced by the pipeline, and enables fast ML model development, ML model retraining, and experimentation for data scientists.

### System for Automatic Machine Learning Application

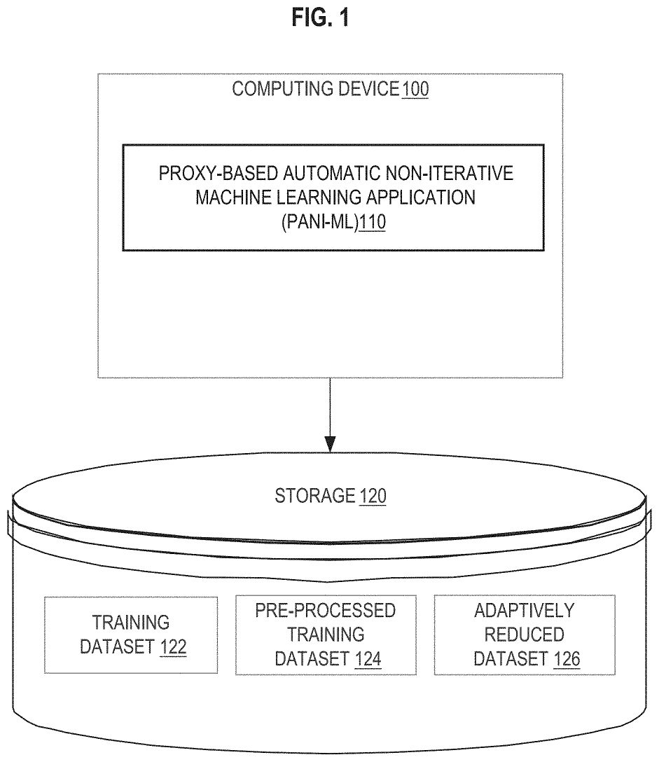

FIG. 1 depicts a block diagram of an example computing device 100 running a PANI-ML application 110 that automatically identifies and configures an ML model to fit a particular training dataset, such as training dataset 122 stored at storage 120, according to techniques described herein. Specifically, computing device 100 is communicatively connected to persistent storage 120, which includes training dataset 122 comprising a plurality of labeled data samples. According to one or more embodiments, the data samples stored in storage 120 may be formatted in any way, including as graph data, relational data, Resource Description Framework (RDF) data, structured data, etc.

### Proxy Models

A proxy model used by PANI-ML application 110 includes a particular set of hyperparameters that is determined to be likely to optimize the functioning of the ML algorithm implemented by the proxy model. Accordingly, a proxy model used for PANI-ML application 110 satisfies the following qualities: (a) the proxy model is an instance of an ML algorithm; (b) has relative performance that is representative of a tuned model implementing the ML algorithm, without requiring additional hyperparameter tuning; and (c) is able to accurately predict relative ranking of different dataset subsets (both column-wise and row-wise) with respect to the ML algorithm. For example, using such a proxy model, the best feature subset out of K different feature subsets of the target training dataset could be identified by ranking the scores of the K different feature subsets resulting from application of the proxy model. Examples of proxy models include mini-ML variants, described in the Mini-ML Application incorporated by reference above.

In order to generate a useful set of proxy models for the PANI-ML pipeline, the primary challenge is to find a single proxy model per ML algorithm that is predictive for any never-before-seen dataset. According to an embodiment, metalearning is leveraged to identify appropriate proxy models for a set of ML algorithms by observing each algorithm's behavior on a wide variety of datasets and hyperparameters. Metalearning leverages this knowledge of how different ML model configurations behave on a wide variety of datasets and is used to populate hyperparameter configurations for proxy models implementing the different ML algorithms. Specifically, metalearning involves three main steps, which are performed offline in preparation for the PANI-ML pipeline: (a) generate a large number of representative hyperparameter variations per algorithm (i.e., candidate proxy models), (b) evaluate each model's performance on a wide-variety of datasets, and (c) heuristically identify a proxy model per algorithm, from all candidates, that best quantifies the performance of the algorithm across all of the datasets.

Proxy models are performance predictors that PANI-ML application 110 uses to make the PANI-ML pipeline iteration-free, and to solve the cold-start problem, allowing the stages to identify performant solutions in less time than would be required if the stages were started without the proxy models. Specifically, stages of the PANI-ML pipeline use these proxy models to make fast and accurate decisions to efficiently narrow down the search space. To illustrate, algorithm selection uses proxy models to quickly rank algorithms, adaptive data reduction uses a proxy model to identify a relevant segment of the dataset for model training, and hyperparameter selection uses a proxy model to bootstrap the process of selecting hyperparameters for the final model. Furthermore, according to an embodiment, in which a second training data processing phase is included in the PANI-ML pipeline after an algorithm selection stage, one or more proxy models are also used to process the training dataset.

### Proxy-Based Automatic Non-Iterative Machine Learning Pipeline

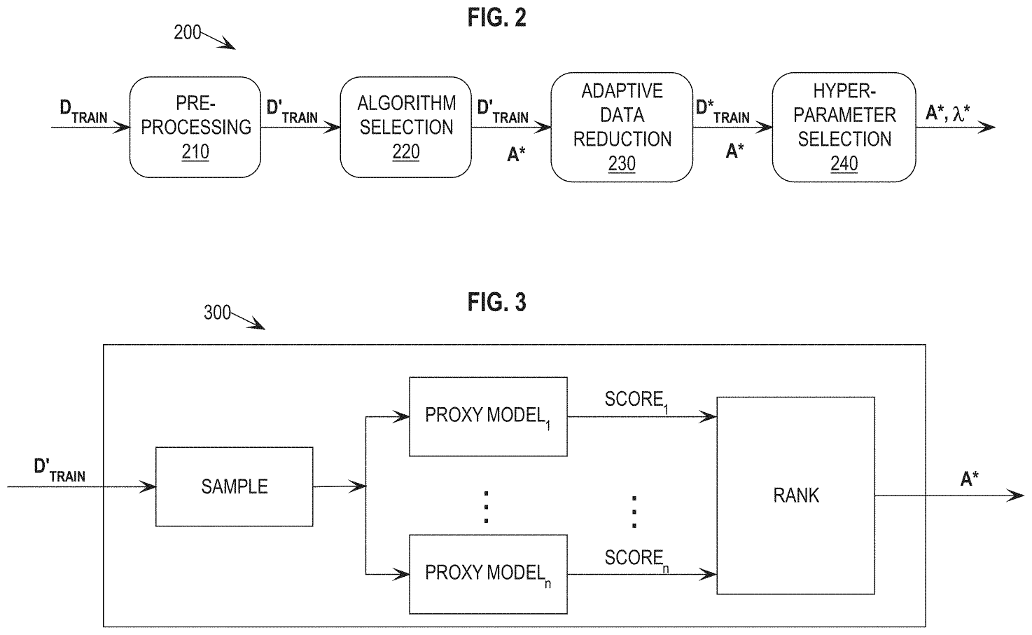

FIG. 2 depicts an example PANI-ML pipeline 200, according to the techniques described herein. Example PANI-ML pipeline 200 includes stages 210-240 ordered according to a pre-defined sequence. To illustrate these stages, assume that PANI-ML application 110 determines to configure an ML model for training dataset 122, e.g., based on a request received at the application. According to an embodiment, in response to this determination, PANI-ML application 110 identifies configuration parameters for an ML model for dataset 122 according to stages 210-240. According to an embodiment, all stages of the PANI-ML pipeline are parallelized wherever possible. For instance, all per-algorithm, per-feature, and per-hyperparameter computations are executed in parallel.

### Processing Training Data

According to an embodiment, the sequence of stages for pipeline 200 starts with a data pre-processing stage 210, during which PANI-ML application 110 performs, on training dataset 122, a set of pre-processing operations, such as missing value imputation, label encoding, and normalization. Stage 210 results in a pre-processed training dataset 124 that is based on training dataset 122. According to an embodiment, during stage 210, a pre-defined series of pre-processing operations are performed on training dataset 122 to produce pre-processed training dataset 124. According to an embodiment, during stage 210, pre-processing operations performed on training dataset 122 depend on the types of data that are present in the dataset, such as time series data, image data, tabular data, etc. For example, PANI-ML application 110 detects a particular type of data in dataset 122 and, based on this detection, applies on the data of the particular type a set of pre-processing operations associated with the detected type of data. The subsequent stages of example pipeline 200 are described herein as being based on pre-processed training dataset 124 for illustrative purposes.

### Algorithm Selection

The next stage of example pipeline 200, after pre-processing stage 210, is an algorithm selection stage 220. At stage 220, a machine learning algorithm, of a plurality of machine learning algorithms, is selected to fit to the training dataset. In the example of PANT-ML pipeline 200, algorithm selection is based on the pre-processed training dataset 124 produced at stage 210. To illustrate, at stage 220, PANI-ML application 110 determines the best algorithm (A*) for pre-processed training dataset 124.

Algorithm selection can have a significant impact on the achieved score for the model produced by PANI-ML application 110. Subsequent stages of the pipeline depend on an underlying ML algorithm, and settling the algorithm selection before performing adaptive data reduction (ADR) at stage 230 and/or hyperparameter selection at stage 240 eliminates the need to perform iterative configuration parameter exploration based on different ML algorithms for a given training dataset.

While identifying an optimal ML model for a target training dataset is guaranteed by exhaustively training every algorithm on the target dataset, such exhaustive training is time-consuming and expensive. Instead of performing exhaustive training, PANI-ML application 110 models automatic algorithm selection as a score prediction problem. According to an embodiment, at stage 220, PANI-ML application 110 uses fast per-algorithm proxy models to accurately rank algorithms for a given dataset, quickly narrowing down the search space for subsequent stages of the PANI-ML pipeline. As described above, these proxy models act as indicators of how well a given algorithm will perform on a dataset of interest. This technique allows PANI-ML application 110 to settle the ML algorithm parameter of the model configuration, which narrows the search space while still allowing the optimizer to identify a close-to-optimal model configuration. Also, the highly predictive nature of the proxy models helps to mitigate score degradation, which would normally be associated with a non-iterative AutoML pipeline.

FIG. 3 depicts an example algorithm selection block diagram comprising dataset sampling, proxy model evaluation, and ranking of obtained cross-validation scores used to select the best algorithm (A*). The proxy models provide an indication of the tuned score of the target dataset on each candidate algorithm relative to other candidate algorithms. According to an embodiment, the proxy models for all candidate algorithms are executed in parallel and the average cross-validation score is used to rank the candidate algorithms. Algorithm selection uses scores from executing the proxy models representing candidate algorithms to identify a relative ranking between algorithms, where the selected algorithm has the highest relative ranking.

To further optimize the runtime of stage 220 for large datasets, techniques described herein sample pre-processed training dataset (D′ₜᵣₐᵢₙ) given that proxy models only need a small fraction (e.g. 1-5%) of the full dataset to work effectively. The sampling for a classification task is done per target class (e.g., malign or benign are target classes in a cancer dataset), where classes with more samples are only subsampled without diluting information on classes with already minimal representation in the dataset. The best algorithm (A*), corresponding to the proxy model that produces the highest score during stage 220, is passed on to the next stage.

### Second Pre-Processing Phase

According to an embodiment, a second pre-processing stage is performed after ML algorithm selection, which utilizes a proxy model that implements the selected ML algorithm. Specifically, during this second pre-processing stage, PANI-ML application 110 uses a proxy model that implements the selected ML algorithm to rank the best pre-processing approach/algorithm that most benefits the selected ML algorithm, in a manner similar to the ML algorithm ranking performed in connection with algorithm selection stage 220. In this embodiment, starting with a simple static pre-processing stage 210 before algorithm selection stage 220, and then tuning the pre-processor for a chosen ML algorithm during a second pre-processing stage, retains the non-iterative nature of the pipeline while allowing for optimization of data pre-processing based on the chosen ML algorithm.

### Adaptive Data Reduction

After algorithm selection stage 220, PANI-ML application 110 performs adaptive data reduction (ADR) stage 230. Adaptive data reduction is tailored to the chosen ML algorithm selected at stage 220 and, according to an embodiment, is performed using a proxy model that implements the chosen ML algorithm.

At ADR stage 230, feature selection is performed, on the training dataset, based at least in part on the selected machine learning algorithm to produce a selected set of features of the training data set. Feature selection identifies the features that are most helpful to predict the labels for the training dataset. To illustrate, with knowledge of the selected algorithm (A*), PANI-ML application 110 selects a subset of features for the dataset without compromising model performance.

According to an embodiment, PANI-ML application 110 also identifies a subset of rows of the training dataset based on which the model may be trained without compromising model performance. Row selection pairs down the rows of the dataset to a strict subset of rows (i.e., less than all of the rows of the dataset) that provide the information required to train the ML model without requiring the ML model to be trained on the entire dataset. Row selection helps to rapidly train an ML model, e.g., to reduce the time required to produce trial trained ML models during hyperparameter selection.

Feature selection is typically expensive, depending on the size of the dataset. Thus, according to an embodiment, row sampling is performed prior to feature selection, which reduces the search space required for feature selection thereby reducing the computing resources required to perform feature selection.

As shown in FIG. 2, D*train represents an adaptively reduced dataset 126 resulting from ADR stage 230 (i.e., resulting from feature selection and, potentially, from row selection) based on pre-processed training dataset 124. Both row sampling and feature selection in this stage rely on proxy models to quickly score samples and subsets. Dataset reduction by means of sampling rows and/or columns can significantly improve the runtime of the hyperparameter selection stage. Furthermore, a sample that is representative of the original dataset will have a minimal impact on model score relative to the model score that would be produced using the original dataset. A novel sampling approach is described herein, which relies on a chosen algorithm (A*), provided by algorithm selection stage 220, to generate the most efficient sample of the dataset for adaptively reduced dataset 126.

### Feature Selection

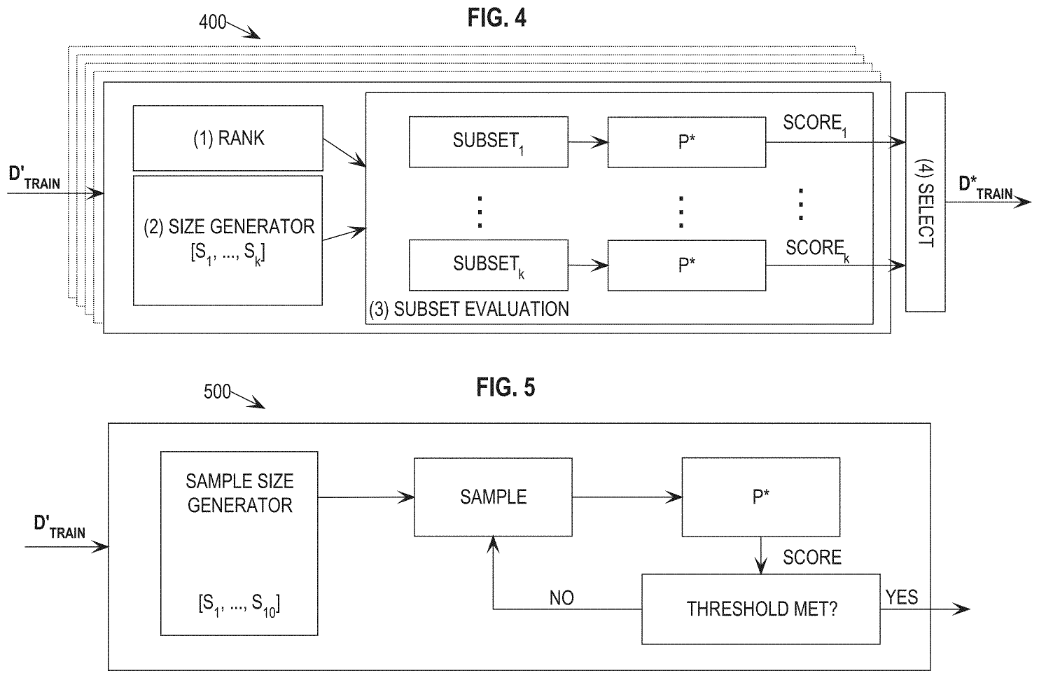

The goal of feature selection is to find a subset of dataset features that are representative of the original dataset. FIG. 4 depicts a feature selection block diagram comprising feature ranking, subset size generation, proxy model-based subset evaluation, and ranking of obtained cross-validation scores used to select the best feature subset. Embodiments can be split into four main steps as depicted in FIG. 4: (1) feature ranking, (2) subset size generation, (3) subset evaluation, and (4) subset selection.

Feature ranking is the procedure by which the features in training dataset 124 are ordered by their importance with regard to predicting labels of the dataset. According to an embodiment, multiple ranking algorithms are used in order to accommodate a wide variety of datasets. An example of a ranking algorithm is random forest-based feature importance ranking, where the ranking is arrived at using the feature importance order. Similarly, there are other ranking functions such as using correlations between each feature and target predictions, or using magnitude of coefficients of a linear model, etc. Techniques described herein generate multiple subset sizes, from the features ranked according to each of the multiple ranking functions, by using an exponential growth function. The multiple subset sizes resulting from each ranking function are evaluated on the proxy model (P*) representing the selected algorithm (A*). All of these evaluations are ranked, and the feature subset that produces the highest score on the proxy model is selected.

### Row Sampling

The goal of row sampling is to select a subset of the rows of training dataset 124 that is representative of the original dataset. According to an embodiment, identification of a representative subset of data rows is accomplished by climbing the dataset learning curve.

FIG. 5 depicts a row sampling block diagram comprising dataset sampling, proxy model evaluation, and ranking of obtained cross-validation scores used to select the best dataset sample and class distribution. As depicted in FIG. 5, training dataset 124 is sampled iteratively from a small subset to the full dataset size and each sample is scored by the proxy model (P*) representing the algorithm (A*) selected by algorithm selection. According to an embodiment, the selected subset of data rows is the smallest sample of the dataset that does not sacrifice the quality of the model. Consecutive sample sizes, with increasing size, are tried on P* until a score tolerance threshold is met, wherein increasing the sample size no longer improves the model score by more than a threshold (e.g., 1%). If all of the sample sizes are exhausted without meeting the threshold, all rows of the feature-selected dataset are used for hyperparameter selection.

### Hyper-Parameter Selection

At hyperparameter selection stage 240, a novel hyperparameter optimizer, referred to herein as “HyperGD”, of PANI-ML application 110 tunes the hyperparameters for the selected ML algorithm using adaptively reduced dataset 126. Specifically, at stage 240, based, at least in part, on the selected set of features from at least a portion of the training data set, a set of hyper-parameters of a machine learning model that implements the selected machine learning algorithm are tuned to produce a tuned machine learning model. During this stage, PANI-ML application 110 aims to fine tune the hyperparameters (λ*) of the selected algorithm (A*). Performing this optimizing step last ensures that selection of hyperparameters is performed using the reduced dataset 126 and on the selected ML model, thereby providing significant cost savings for the hyperparameter tuning. Stage 240 is the most time-consuming stage of the PANI-ML pipeline, and it greatly benefits from the streamlined dataset 126 resulting from ADR stage 230. Specifically, ADR stage 230 removes features that are less-correlated to the results, which aids in convergence. Also, according to an embodiment, ADR stage 230 intelligently reduces the dataset size, which allows HyperGD to run more quickly.

According to an embodiment, hyperparameters from the proxy model (P*) that implements the selected ML algorithm (A*) are used to bootstrap hyperparameter configurations for HyperGD. Because the hyperparameters of P* are metalearned to be useful for a wide variety of datasets, utilizing these hyperparameters as a starting point for at least some of the hyperparameter configurations used by HyperGD helps address the cold-start problem for hyperparameter selection, speeding it up for any given dataset.

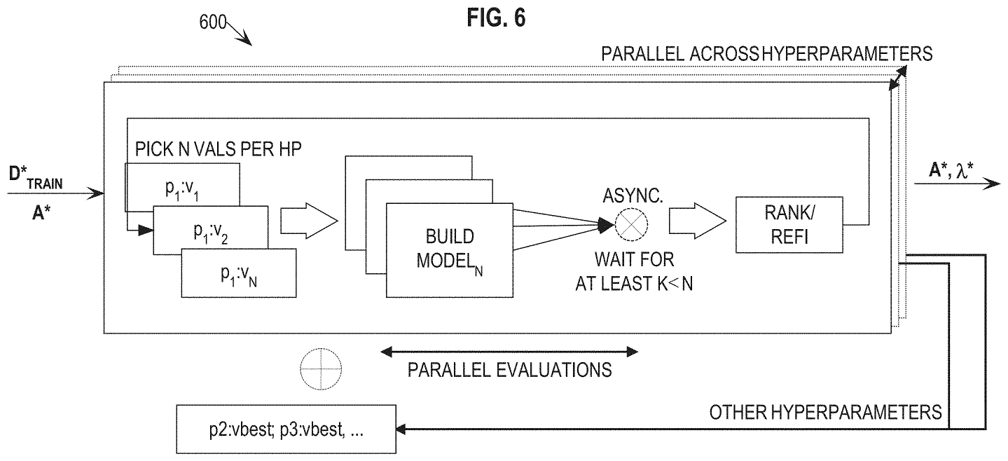

FIG. 6 depicts a HyperGD block diagram, which parallelizes evaluation of hyperparameters, and also parallelizes evaluation of candidate values of each hyperparameter. This parallelization further increases the efficiency of this stage. Techniques described herein achieve this high degree of parallelism by asynchronously gathering results from each batch of model evaluations. According to an embodiment, the best hyperparameters from all completed trials are assimilated upon launching any new trial. One advantage of the asynchronous optimizer is the ability to update the best value for each hyperparameter without waiting for the entire batch of trial ML models to complete training/testing, resulting in significant speedup.

HyperGD comprises two main stages:
1. Rapid search space reduction using gradients, which balances exploitation vs. exploration. This novel approach is referred to herein as Gradient-based Search Space Reduction (GrSSR).
2. Fine tuning of individual hyperparameters using a short gradient-descent in the narrowed search space.

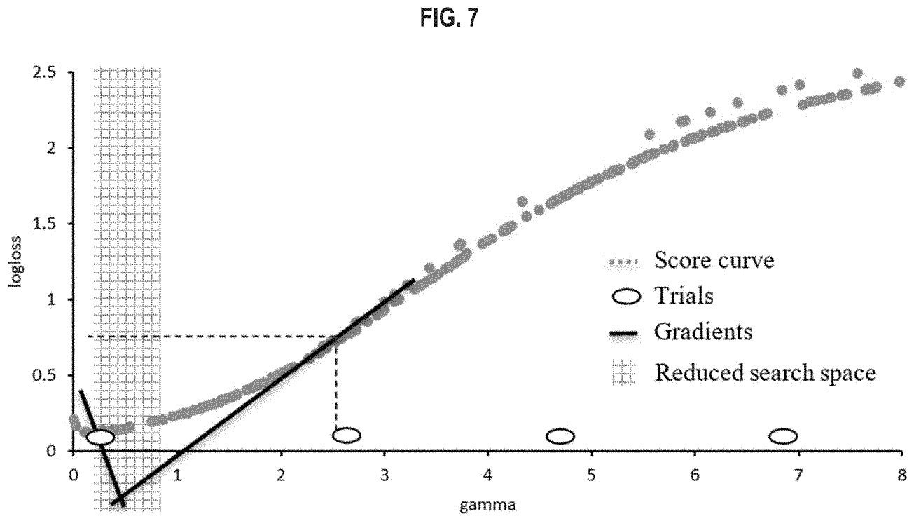

The goal of GrSSR during hyperparameter selection stage 240 is to rapidly narrow the search space for each hyperparameter, given a wider search range. FIG. 7 depicts a sample visualization of the GrSSR algorithm in action, while tuning a gamma hyperparameter of an example support vector machine (SVM) classifier trained on a real-world dataset. For ease of explanation, FIG. 7 depicts a simple 2-D search space, where the x-axis represents values for a given hyperparameter, and the y-axis represents the objective logloss error metric (where lower is better).

With the goal of narrowing the initial search range towards the minimum of the error curve, M point-pairs are selected across the search space, and the gradients are estimated at these points. Each point pair is E apart where the E is selected relative to the initial range of the search space. Next, the direction of the minima is estimated by finding the intersection point using the gradients of the top two pairs, as shown in FIG. 7. PANI-ML application 110 then narrows the search range by picking the next M point-pairs in the vicinity of the intersection of the two gradients, rapidly reducing the search space.

According to an embodiment, two approximations are made that parallelize and speed up the hyperparameter selection process:
1. It is assumed that hyperparameters can be optimized independently of each other. This simplifying assumption allows for complete parallelization of the search across all hyperparameter dimensions without significant synchronization. Each parallel hyperparameter search eagerly updates the other parallel hyperparameter searches with its best hyperparameter value found so far.
2. To avoid synchronizing for every batch of trials, PANI-ML application 110 waits for a subset of the trials to complete in order to proceed to the next iteration. The still-pending trials are utilized to help refine the search space further whenever they complete.

When the search space cannot be further narrowed, techniques described herein use a quick gradient descent (GD) to fine-tune the hyperparameter values. Application of GD is also fully parallelized across hyperparameter dimensions. Application of GD to fine-tune the hyperparameters concludes the novel HyperGD algorithm. As shown above, GrSSR inherently provides a convergence criterion that is lacking in most other alternatives.

According to an embodiment, the values used for the hyperparameters of trial models produced by HyperGD, other than the hyperparameters being tested, are drawn from a metalearned proxy model implementing the selected ML algorithm. These hyperparameter values are known to represent a good approximation of what is most efficient for a trained model. As such, using metalearned proxy models as at least one of the starting hyperparameter configurations helps address the cold-start problem for hyperparameter selection, further speeding it up for any given dataset. According to an embodiment, other starting hyperparameters for trial models are also used by HyperGD, including the default parameters for the selected ML algorithm.

### Training the Configured ML Model

The ML model configured by PANI-ML application 110 is trained, using the selected set of features from at least a portion of the training data set, to produce a trained machine learning model. For example, PANI-ML application 110 causes the ML model configured according to pipeline 200 to be trained using the feature subset selected during ADR stage 230 for all of the rows in pre-processed training dataset 124. As another example, to conserve resources and training time, PANI-ML application 110 causes the ML model to be trained on a strict subset of rows of the training dataset that were identified during ADR stage 230. Alternatively, PANI-ML application 110 retains the version of the ML model (generated during hyperparameter selection stage 240) that was trained, using the final tuned set of hyperparameters, on the strict subset of rows of the training dataset that were identified during ADR stage 230. In this example, this retained version of the ML model is used as the final trained ML model.

The resulting trained ML model may be used to formulate predictions for one or more data samples not included in the training data set. The one or more data samples not included in the training data set are not associated with labels as are the data samples of the training dataset. For example, PANI-ML application 110 receives a request to use the trained ML model that is fit to training dataset 122 to infer a prediction for an unlabeled data sample. In response, PANI-ML application 110 uses the model to infer a prediction and stores information indicating the prediction on non-transitory computer-readable media, such as storage 120.

### Time Budget

To make PANI-ML application 110 more robust, according to an embodiment, a time budget feature is included to prevent PANI-ML application 110 from terminating without producing a tuned model. In this embodiment, PANI-ML application 110 accomplishes a tuned model guarantee by respecting a time budget at every stage of the pipeline. To illustrate, the order of stages in PANI-ML pipeline 200 are such that decisions with higher payoff are performed first. For example, selection of an appropriate ML algorithm, which is performed early in the pipeline, generally has more impact on effectiveness of the resulting ML model than feature selection or hyperparameter tuning.

For large datasets working on a time budget or for very short time budgets, not all pipeline stages may have a chance to fully execute. Therefore, techniques described herein implement fallback strategies to ensure that PANI-ML pipeline 200 produces a tuned model, regardless of in which pipeline stage the time budget is exhausted. For example, if the time budget is exhausted before the algorithm selection stage is completed (i.e., a very short time budget), PANI-ML application 110 defaults to a pre-determined pre-tuned model, e.g., a NaiveBayes proxy model, that is then trained on the full dataset.

As a further example, if the time budget is exhausted during ADR stage 230, the dataset feature sample with the highest cross-validation score is selected to be the feature-selected training dataset for the ML model. Because (in this example) the budget is exhausted before the HyperGD stage is reached, PANI-ML application 110 uses a proxy model corresponding to the selected algorithm as the tuned model, which is then trained based on the dataset sample with the highest cross-validation score.

As yet another example, if the time budget is exhausted during the hyperparameter selection stage, techniques described herein select the best tuned model so far, based on the maximum validation score. Here, validation scores are computed using one of: a K-fold cross-validation (CV), which is stratified for classification tasks; or a score on a held-aside validation set using a desired objective score metric, such as accuracy or f1 score for classification tasks, or mean squared error for regression tasks. For CV, the mean of K-fold scores is maximized. This model is trained using the feature-selected training dataset identified by PANI-ML application 110. Thus, embodiments are able to produce a well-tuned ML model even when acting under time constraints.

According to an embodiment, a user indicates a finite time budget for a given ML model configuration request, and PANI-ML application 110 allocates a portion of the indicated time budget to each stage in the PANI-ML pipeline. In this embodiment, when a pipeline stage is not completed within the assigned time budget, PANI-ML application 110 cuts off functioning of the stage (as described above) and moves on to the next stage of the pipeline.

### Evaluation

The benefits of an AutoML optimizer are measured using two main metrics: (1) the goodness of the final tuned model, called model performance or score; and (2) the amount of time and resources used to achieve that score, called speed or efficiency. A quantitative comparison of PANI-ML with several state-of-the-art open-source AutoML alternatives is herein presented. To evaluate the PANI-ML pipeline, the predictiveness (model score) and speed of PANI-ML are compared against two state-of-the-art open-source packages, Auto-sklearn and H2O.

A logloss metric is used to measure model performance, where lower logloss is better. To understand efficiency, the resources to each optimizer are varied in terms of a time budget argument (on the same machine) and model performance for each scenario is measured. Each optimizer can choose to utilize their entire time budget (Auto-sklearn), or converge on a solution earlier (H2O, PANI-ML).

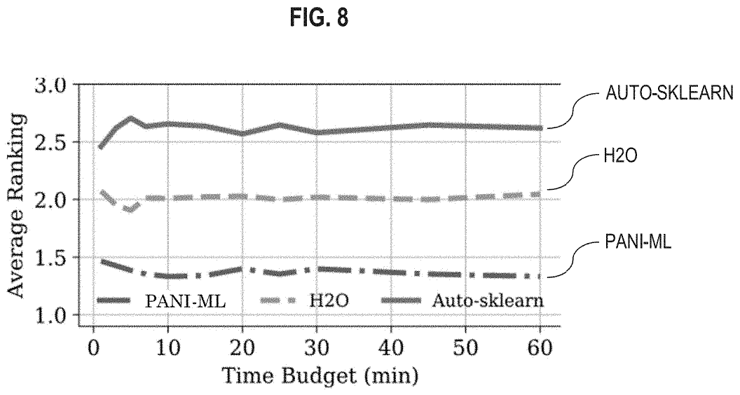

To compare efficiency across the AutoML pipelines, the average ranking of the three pipelines is measured with 11 different time budgets of 1, 3, 5, 7, 10, 15, 20, 25, 30, 45, 60 minutes and five different seeds over a 30-dataset test corpus with varying attributes. Each AutoML system is ranked per run (given time budget and seed) based on the leave-out test set score of each dataset, and the ranks are averaged across datasets per run. Any incomplete runs are assigned the worst rank of ‘3’. The result is shown in FIG. 8, which depicts a graph of average rankings across 30 datasets and five random seeds, versus varying time budgets, for Auto-sklearn, H2O, and PANI-ML. Note that rank 1 is best.

As shown in FIG. 8, H2O performs significantly better than Auto-sklearn across all the runs, and PANI-ML is the most efficient out of all three. Interestingly, there is a significant improvement in ranking for H2O and PANI-ML in the less-than-five-minute region. This is, primarily, because H2O does not produce a final model within those time budgets. H2O average rank improves once more results are available after the five-minute mark.

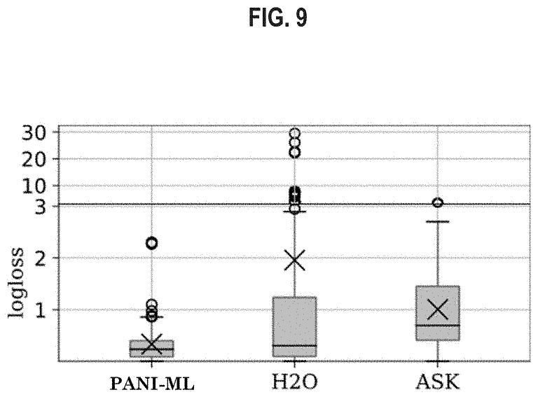

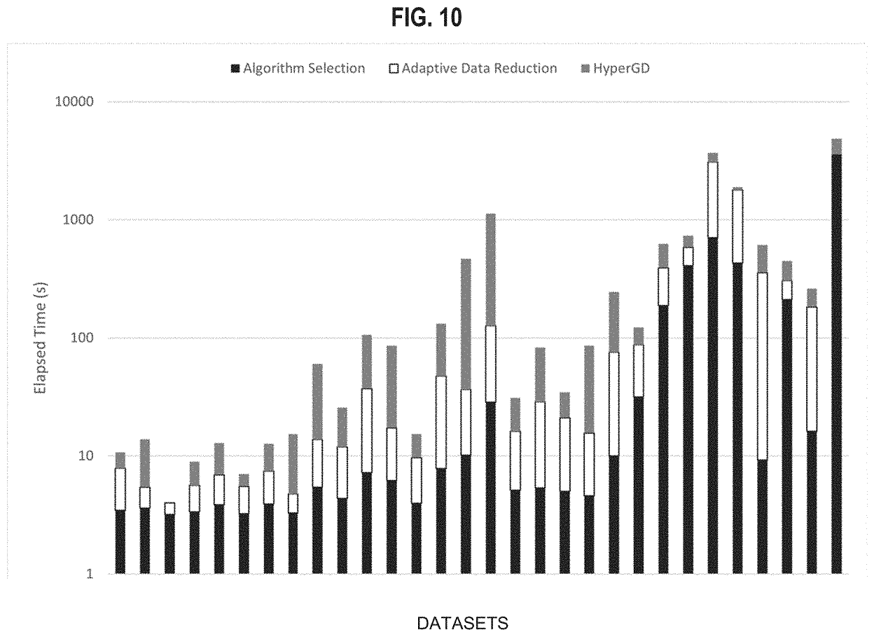

The ranking plots of FIG. 8 only show the efficiency part of the story. The raw performance of the pipelines is examined by plotting the distribution of tuned model performance given a full hour to optimize (shown in FIG. 9). Specifically, FIG. 9 depicts a comparison between PANI-ML, H2O, and Auto-sklearn with 60-minute time budgets on 30 datasets. Reported numbers are the average of five runs each with different random seeds. The y-axis of FIG. 9 shows the logloss error (lower is better).

Overall, PANI-ML has a very tight distribution of logloss with an average logloss (identified by the cross) of 0.338, which is much better than the performance of H2O and Auto-sklearn, corroborating the ranking plot of FIG. 8. Interestingly, when comparing Auto-sklearn and H2O, the distribution is only marginally different from each other. But in fact, the average logloss for H2O is 1.882, which is much worse than the 1.014 that Auto-sklearn achieves. This is primarily because H2O seems to perform very poorly for multiple datasets (shown by the many outliers identified by circles), performing significantly better on a handful of other runs.

Even using the entirety of the maximum time budget of one hour, H2O and Auto-sklearn are not able to achieve better results than PANI-ML for most datasets. On the other hand, PANI-ML is able to quickly converge on a solution, finishing far ahead of the allotted time budget in most cases, as can be seen from the runtime breakdown across all test datasets in FIG. 10. Specifically, FIG. 10 depicts a chart with the respective runtime breakdown of stages in PANI-ML across different test datasets of a test corpus for the 60-minute time budget case. The y-axis is on a logarithmic scale to better visualize PANI-ML's small runtimes.

In FIG. 10, only four out of 30 datasets require the full time budget of 60 minutes; PANI-ML completes model parameter selection for the majority of datasets within 500 seconds. This gives PANI-ML an average speedup of 74× over H2O and 118× over Auto-sklearn, when comparing their aggregate runtimes across the test corpus. On average, across test datasets, the algorithm selection stage takes 21% of PANI-ML's runtime, the ADR stage takes 34%, and the HyperGD stage takes 45% of PANI-ML's runtime. Even though PANI-ML is iteration free, each stage adapts and optimizes to the given dataset differently, taking different amounts of time for the different datasets.

PANI-ML performs very effectively and efficiently for large datasets, which other pipelines struggle to optimize under the same time budget. The quick and accurate algorithm selection stage of PANI-ML benefits from use of proxy models. The non-iterative nature of PANI-ML and reliance on proxy models to accurately select the best algorithm for a new dataset, at an early pipeline stage, is at least in part what enables the PANI-ML optimizer to significantly outperform iterative optimizers.

### Machine Learning Model

A machine learning model is trained using a particular machine learning algorithm. Once trained, input is applied to the machine learning model to make a prediction, which may also be referred to herein as a predicated output or output.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output, as described above. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, executed, and/or as generating an output or predication, a computer system process executing a machine learning algorithm applies the model artifact against the input to generate a predicted output. A computer system process executes a machine learning algorithm by executing software configured to cause execution of the algorithm.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e., configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, Matlab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input node, the activation value is simply an input value for the input. For an activation neuron, the activation value is the output of the respective activation function of the activation neuron.

Each edge from a particular node to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation node, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of nodes in layer L−1 and L is N[L−1] and N[L], respectively, the dimensions of matrix W are N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input node. The particular input may be stored as vector. Training data comprises multiple inputs, each being referred to as sample in a set of samples. Each sample includes a value for each input node. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every node in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of nodes and/or edges determines the size of matrices needed to implement a neural network. The smaller the number of nodes and edges in a neural network, the smaller matrices and amount of memory needed to store matrices. In addition, a smaller number of nodes and edges reduces the amount of computation needed to apply or train a neural network. Less nodes means less activation values need be computed, and/or less derivative values need be computed during training.

Properties of matrices used to implement a neural network correspond neurons and edges. A cell in a matrix W represents a particular edge from a node in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e., number of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e., ceases to reduce) or vanishes beneath a threshold (i.e., approaches zero). Example mathematical formulae and techniques for feedforward multilayer perceptron (MLP), including matrix operations and backpropagation, are taught in a related reference “Exact Calculation Of The Hessian Matrix For The Multi-Layer Perceptron,” by Christopher M. Bishop, the entire contents of which are hereby incorporated by reference as if fully set forth herein.

Model training may be supervised or unsupervised. For supervised training, the desired (i.e., correct) output is already known for each example in a training set. The training set is configured in advance by (e.g., a human expert, or via the labeling algorithm described above) assigning a categorization label to each example. For example, the training set for a given ML model is labeled, by an administrator, with the workload types and/or operating systems running on the server device at the time the historical utilization data was gathered. Error calculation and backpropagation occurs as explained above.

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Autoencoder implementation and integration techniques are taught in related U.S. patent application Ser. No. 14/558,700, entitled “AUTO-ENCODER ENHANCED SELF-DIAGNOSTIC COMPONENTS FOR MODEL MONITORING”. That patent application elevates a supervised or unsupervised ANN model as a first class object that is amenable to management techniques such as monitoring and governance during model development such as during training.

### Deep Context Overview

As described above, an ANN may be stateless such that timing of activation is more or less irrelevant to ANN behavior. For example, recognizing a particular letter may occur in isolation and without context. More complicated classifications may be more or less dependent upon additional contextual information. For example, the information content (i.e., complexity) of a momentary input may be less than the information content of the surrounding context. Thus, semantics may occur based on context, such as a temporal sequence across inputs or an extended pattern (e.g., compound geometry) within an input example. Various techniques have emerged that make deep learning be contextual. One general strategy is contextual encoding, which packs a stimulus input and its context (i.e., surrounding/related details) into a same (e.g., densely) encoded unit that may be applied to an ANN for analysis. One form of contextual encoding is graph embedding, which constructs and prunes (i.e., limits the extent of) a logical graph of (e.g., temporally or semantically) related events or records. The graph embedding may be used as a contextual encoding and input stimulus to an ANN.

Hidden state (i.e., memory) is a powerful ANN enhancement for (especially temporal) sequence processing. Sequencing may facilitate prediction and operational anomaly detection, which can be important techniques. A recurrent neural network (RNN) is a stateful MLP that is arranged in topological steps that may operate more or less as stages of a processing pipeline. In a folded/rolled embodiment, all of the steps have identical connection weights and may share a single one-dimensional weight vector for all steps. In a recursive embodiment, there is only one step that recycles some of its output back into the one step to recursively achieve sequencing. In an unrolled/unfolded embodiment, each step may have distinct connection weights. For example, the weights of each step may occur in a respective column of a two-dimensional weight matrix.

A sequence of inputs may be simultaneously or sequentially applied to respective steps of an RNN to cause analysis of the whole sequence. For each input in the sequence, the RNN predicts a next sequential input based on all previous inputs in the sequence. An RNN may predict or otherwise output almost all of the input sequence already received and also a next sequential input not yet received. Prediction of a next input by itself may be valuable. Comparison of a predicted sequence to an actually received (and applied) sequence may facilitate anomaly detection, as described in detail above.

Unlike a neural layer that is composed of individual neurons, each recurrence step of an RNN may be an MLP that is composed of cells, with each cell containing a few specially arranged neurons. An RNN cell operates as a unit of memory. An RNN cell may be implemented by a long short term memory (LSTM) cell. The way LSTM arranges neurons is different from how transistors are arranged in a flip flop, but a same theme of a few control gates that are specially arranged to be stateful is a goal shared by LSTM and digital logic. For example, a neural memory cell may have an input gate, an output gate, and a forget (i.e., reset) gate. Unlike a binary circuit, the input and output gates may conduct an (e.g., unit normalized) numeric value that is retained by the cell, also as a numeric value.

An RNN has two major internal enhancements over other MLPs. The first is localized memory cells such as LSTM, which involves microscopic details. The other is cross activation of recurrence steps, which is macroscopic (i.e., gross topology). Each step receives two inputs and outputs two outputs. One input is external activation from an item in an input sequence. The other input is an output of the adjacent previous step that may embed details from some or all previous steps, which achieves sequential history (i.e., temporal context). The other output is a predicted next item in the sequence. Example mathematical formulae and techniques for RNNs and LSTM are taught in related U.S. patent application Ser. No. 15/347,501, entitled “MEMORY CELL UNIT AND RECURRENT NEURAL NETWORK INCLUDING MULTIPLE MEMORY CELL UNITS.”

Sophisticated analysis may be achieved by a so-called stack of MLPs. An example stack may sandwich an RNN between an upstream encoder ANN and a downstream decoder ANN, either or both of which may be an autoencoder. The stack may have fan-in and/or fan-out between MLPs. For example, an RNN may directly activate two downstream ANNs, such as an anomaly detector and an autodecoder. The autodecoder might be present only during model training for purposes such as visibility for monitoring training or in a feedback loop for unsupervised training. RNN model training may use backpropagation through time, which is a technique that may achieve higher accuracy for an RNN model than with ordinary backpropagation. Example mathematical formulae, pseudocode, and techniques for training RNN models using backpropagation through time are taught in related W.I.P.O. patent application No. PCT/US2017/033698, entitled “MEMORY-EFFICIENT BACKPROPAGATION THROUGH TIME”.

### Random Forest

Random forests or random decision forests are an ensemble of learning approaches that construct a collection of randomly generated nodes and decision trees during the training phase. The different decision trees are constructed to be each randomly restricted to only particular subsets of feature dimensions of the dataset. Therefore, the decision trees gain accuracy as the decision trees grow without being forced to over fit the training data as would happen if the decision trees were forced to be restricted to all the feature dimensions of the dataset. Predictions for the time-series are calculated based on the mean of the predictions from the different decision trees.

The following is an example and non-limiting method of training a set of Random Forest models. A best trained Random Forest ML model is selected, from a set of models resulting from the training phase, to be the basis for instances of a trained ML model. In some embodiments, training data is pre-processed prior to labeling the training data that will be used to train the Random Forest ML model. The pre-processing may include cleaning the readings for null values, normalizing the data, downsampling the features, etc.

In an embodiment, hyper-parameter specifications are received for the Random Forest tch ML model to be trained. Without limitation, these hyper-parameters may include values of model parameters such as number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc. The Random Forest ML model is trained using the specified hyper-parameters and the training dataset (or the pre-processed sequence training data, if applicable). The trained model is evaluated using the test and validation datasets, as described above.

According to embodiments, a determination is made of whether to generate another set of hyper-parameter specifications. If so, another set of hyper-parameter specifications is generated and another Random Forest ML model is trained having the new set of hypermeters specified. All Random Forest ML models trained during this training phase are the set of models from which the best trained ML model is chosen.

### Hardware Overview

Training datasets 122, 124, and 126 may reside in volatile and/or non-volatile storage, including persistent storage 120 or flash memory, or volatile memory of computing device 100. Additionally, or alternatively, one or more of training dataset 122, 124, and 126 may be stored, at least in part, in main memory of a database server computing device.

An application, such as PANI-ML application 110, runs on a computing device and comprises a combination of software and allocation of resources from the computing device. Specifically, an application is a combination of integrated software components and an allocation of computational resources, such as memory, and/or processes on the computing device for executing the integrated software components on a processor, the combination of the software and computational resources being dedicated to performing the stated functions of the application.

One or more of the functions attributed to any process described herein, may be performed any other logical entity that may or may not be depicted in FIG. 1, according to one or more embodiments. In an embodiment, each of the techniques and/or functionality described herein is performed automatically and may be implemented using one or more computer programs, other software elements, and/or digital logic in any of a general-purpose computer or a special-purpose computer, while performing data retrieval, transformation, and storage operations that involve interacting with and transforming the physical state of memory of the computer.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

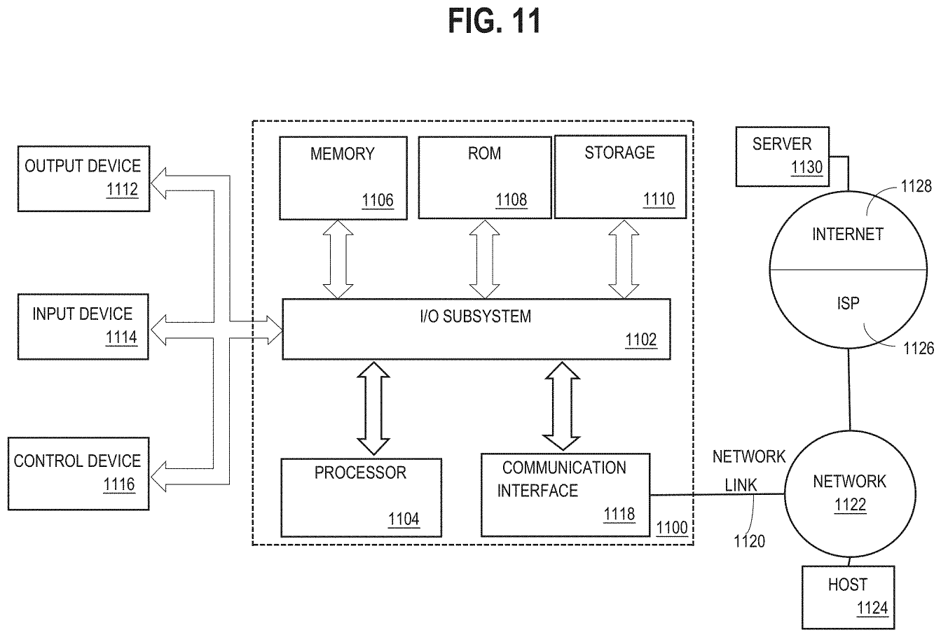

For example, FIG. 11 is a block diagram that illustrates a computer system 1100 upon which an embodiment of the invention may be implemented. Computer system 1100 includes a bus 1102 or other communication mechanism for communicating information, and a hardware processor 1104 coupled with bus 1102 for processing information. Hardware processor 1104 may be, for example, a general-purpose microprocessor.

Computer system 1100 also includes a main memory 1106, such as a random access memory (RAM) or other dynamic storage device, coupled to bus 1102 for storing information and instructions to be executed by processor 1104. Main memory 1106 also may be used for storing temporary variables or other intermediate information during execution of instructions to be executed by processor 1104. Such instructions, when stored in non-transitory storage media accessible to processor 1104, render computer system 1100 into a special-purpose machine that is customized to perform the operations specified in the instructions.

Computer system 1100 further includes a read only memory (ROM) 1108 or other static storage device coupled to bus 1102 for storing static information and instructions for processor 1104. A storage device 1110, such as a magnetic disk, optical disk, or solid-state drive is provided and coupled to bus 1102 for storing information and instructions.

Computer system 1100 may be coupled via bus 1102 to a display 1112, such as a cathode ray tube (CRT), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. This input device typically has two degrees of freedom in two axes, a first axis (e.g., x) and a second axis (e.g., y), that allows the device to specify positions in a plane.

Computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor 1104 executing one or more sequences of one or more instructions contained in main memory 1106. Such instructions may be read into main memory 1106 from another storage medium, such as storage device 1110. Execution of the sequences of instructions contained in main memory 1106 causes processor 1104 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1110. Volatile media includes dynamic memory, such as main memory 1106. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1102. Transmission media can also take the form of acoustic or light waves, such as those generated during radio-wave and infra-red data communications.

Various forms of media may be involved in carrying one or more sequences of one or more instructions to processor 1104 for execution. For example, the instructions may initially be carried on a magnetic disk or solid-state drive of a remote computer. The remote computer can load the instructions into its dynamic memory and send the instructions over a telephone line using a modem. A modem local to computer system 1100 can receive the data on the telephone line and use an infra-red transmitter to convert the data to an infra-red signal. An infra-red detector can receive the data carried in the infra-red signal and appropriate circuitry can place the data on bus 1102. Bus 1102 carries the data to main memory 1106, from which processor 1104 retrieves and executes the instructions. The instructions received by main memory 1106 may optionally be stored on storage device 1110 either before or after execution by processor 1104.

Computer system 1100 also includes a communication interface 1118 coupled to bus 1102. Communication interface 1118 provides a two-way data communication coupling to a network link 1120 that is connected to a local network 1122. For example, communication interface 1118 may be an integrated services digital network (ISDN) card, cable modem, satellite modem, or a modem to provide a data communication connection to a corresponding type of telephone line. As another example, communication interface 1118 may be a local area network (LAN) card to provide a data communication connection to a compatible LAN. Wireless links may also be implemented. In any such implementation, communication interface 1118 sends and receives electrical, electromagnetic, or optical signals that carry digital data streams representing various types of information.

Network link 1120 typically provides data communication through one or more networks to other data devices. For example, network link 1120 may provide a connection through local network 1122 to a host computer 1124 or to data equipment operated by an Internet Service Provider (ISP) 1126. ISP 1126 in turn provides data communication services through the worldwide packet data communication network now commonly referred to as the “Internet” 1128. Local network 1122 and Internet 1128 both use electrical, electromagnetic, or optical signals that carry digital data streams. The signals through the various networks and the signals on network link 1120 and through communication interface 1118, which carry the digital data to and from computer system 1100, are example forms of transmission media.

Computer system 1100 can send messages and receive data, including program code, through the network(s), network link 1120 and communication interface 1118. In the Internet example, a server 1130 might transmit a requested code for an application program through Internet 1128, ISP 1126, local network 1122 and communication interface 1118.

The received code may be executed by processor 1104 as it is received, and/or stored in storage device 1110, or other non-volatile storage for later execution.

### Software Overview

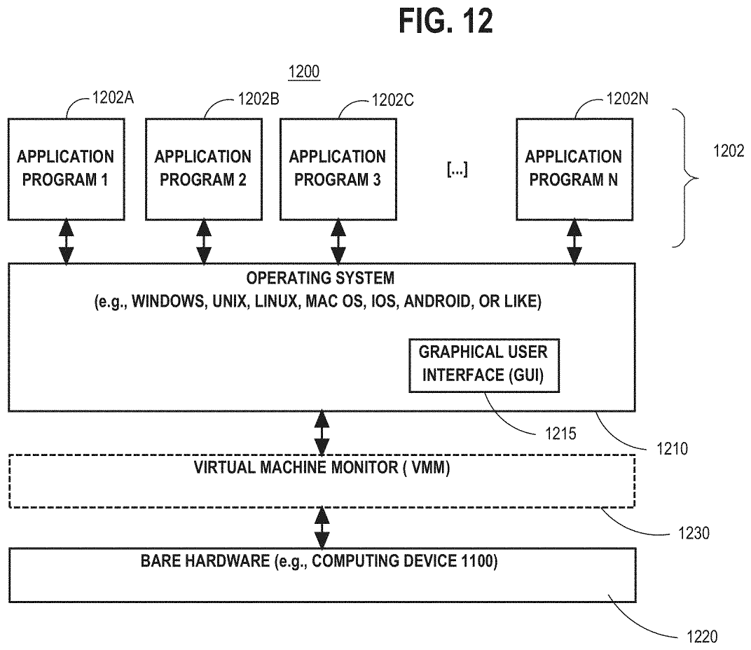

FIG. 12 is a block diagram of a basic software system 1200 that may be employed for controlling the operation of computer system 1100. Software system 1200 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1200 is provided for directing the operation of computer system 1100. Software system 1200, which may be stored in system memory (RAM) 1106 and on fixed storage (e.g., hard disk or flash memory) 1110, includes a kernel or operating system (OS) 1210.

The OS 1210 manages low-level aspects of computer operation, including managing execution of processes, memory allocation, file input and output (I/O), and device I/O. One or more application programs, represented as 1202A, 1202B, 1202C . . . 1202N, may be “loaded” (e.g., transferred from fixed storage 1110 into memory 1106) for execution by the system 1200. The applications or other software intended for use on computer system 1100 may also be stored as a set of downloadable computer-executable instructions, for example, for downloading and installation from an Internet location (e.g., a Web server, an app store, or other online service).

Software system 1200 includes a graphical user interface (GUI) 1215, for receiving user commands and data in a graphical (e.g., “point-and-click” or “touch gesture”) fashion. These inputs, in turn, may be acted upon by the system 1200 in accordance with instructions from operating system 1210 and/or application(s) 1202. The GUI 1215 also serves to display the results of operation from the OS 1210 and application(s) 1202, whereupon the user may supply additional inputs or terminate the session (e.g., log off).

OS 1210 can execute directly on the bare hardware 1220 (e.g., processor(s) 1104) of computer system 1100. Alternatively, a hypervisor or virtual machine monitor (VMM) 1230 may be interposed between the bare hardware 1220 and the OS 1210. In this configuration, VMM 1230 acts as a software “cushion” or virtualization layer between the OS 1210 and the bare hardware 1220 of the computer system 1100.

VMM 1230 instantiates and runs one or more virtual machine instances (“guest machines”). Each guest machine comprises a “guest” operating system, such as OS 1210, and one or more applications, such as application(s) 1202, designed to execute on the guest operating system. The VMM 1230 presents the guest operating systems with a virtual operating platform and manages the execution of the guest operating systems.

In some instances, the VMM 1230 may allow a guest operating system to run as if it is running on the bare hardware 1220 of computer system 1100 directly. In these instances, the same version of the guest operating system configured to execute on the bare hardware 1220 directly may also execute on VMM 1230 without modification or reconfiguration. In other words, VMM 1230 may provide full hardware and CPU virtualization to a guest operating system in some instances.

In other instances, a guest operating system may be specially designed or configured to execute on VMM 1230 for efficiency. In these instances, the guest operating system is “aware” that it executes on a virtual machine monitor. In other words, VMM 1230 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-executed method comprising:
based, at least in part, on a plurality of proxy models that reflect a plurality of machine learning algorithms, selecting a machine learning algorithm, of the plurality of machine learning algorithms, to fit to a training data set;
based, at least in part, on a particular proxy model, of the plurality of proxy models, that reflects the selected ML algorithm, performing feature selection on at least a portion of the training data set to produce a selected set of features of the training data set;
based, at least in part, on the selected set of features from at least a portion of the training data set, tuning a set of hyper-parameters of a machine learning model that implements the selected machine learning algorithm to produce a tuned machine learning model;
training the tuned machine learning model, using the selected set of features from at least a portion of the training data set, to produce a trained machine learning model;
wherein the method is performed by one or more computing devices.

2. The computer-executed method of claim 1, further comprising, prior to selecting the machine learning algorithm, pre-processing the training data set.

3. The computer-executed method of claim 1, wherein each proxy model, of the plurality of proxy models, implements a different machine learning algorithm of the plurality of machine learning algorithms.

4. The computer-executed method of claim 1, wherein:
tuning the set of hyper-parameters of the machine learning model comprises:
training one or more trial machine learning models that implement the selected machine learning algorithm,
wherein each trial machine learning model, of the one or more trial machine learning models, is associated with a different set of hyperparameters that is based, at least in part, on hyperparameters of a proxy model that implements the selected machine learning algorithm.

5. The computer-executed method of claim 1, further comprising, processing the training data set based, at least in part, on a proxy model that implements the selected machine learning algorithm.

6. The computer-executed method of claim 1, further comprising identifying a strict subset of rows, of the training data set, wherein tuning the set of hyper-parameters is performed based on the strict subset of rows.

7. The computer-executed method of claim 1, further comprising identifying a strict subset of rows, of the training data set, wherein feature selection is performed based on the strict subset of rows.

8. The computer-executed method of claim 1, further comprising:
initializing selection of a machine learning algorithm, of the plurality of machine learning algorithms, to fit to a second training data set;
during machine learning algorithm selection for the second training data set, determining that a time limit associated with the second training data set has expired;
responsive to determining that the time limit has expired, training a pre-determined tuned ML model, using the second training data set, to produce a trained machine learning model.

9. The computer-executed method of claim 1, further comprising:
selecting a second machine learning algorithm, of the plurality of machine learning algorithms, to fit to a second training data set;
initializing performance of feature selection on the second training data set, based at least in part on the second machine learning algorithm;
wherein performance of feature selection on the second training data set comprises:
identifying a plurality of dataset samples from the second training data set, and
for each dataset sample, of the plurality of dataset samples, calculating a cross-validation score;
during performance of feature selection on the second training data set, determining that a time limit associated with the second training data set has expired;
responsive to determining that the time limit has expired:
identifying a particular dataset sample, of the plurality of dataset samples, associated with a highest cross-validation score, and
training a pre-tuned ML model, that implements the second machine learning algorithm, using the particular dataset sample, to produce a trained machine learning model.

10. The computer-executed method of claim 1, further comprising:
selecting a second machine learning algorithm, of the plurality of machine learning algorithms, to fit to a second training data set;
performing feature selection on at least a portion of the second training data set, based at least in part on the second machine learning algorithm, to produce a second selected set of features of the second training data set;
initializing tuning of a second set of hyper-parameters of a second machine learning model that implements the second machine learning algorithm based, at least in part, on the second selected set of features from at least a portion of the second training data set;
wherein tuning of the second set of hyper-parameters of the second machine learning model comprises:
training a plurality of trial machine learning models that implement the second machine learning algorithm,
wherein each trial machine learning model, of the plurality of trial machine learning models, is associated with a different set of hyperparameters, and
for each trial machine learning model, of the plurality of trial machine learning models, calculating a validation score;
during tuning of the second set of hyper-parameters of the second machine learning model, determining that a time limit associated with the second training data set has expired;
responsive to determining that the time limit has expired:
identifying a combination of hyperparameters associated with one or more best validation scores, and
training an ML model, that implements the second machine learning algorithm and that is configured with the identified combination of hyperparameters, using the second selected set of features from at least a portion of the second training data set, to produce a trained machine learning model.

11. The computer-executed method of claim 1, further comprising:
formulating a prediction, for a data sample not included in the training data set, using the trained machine learning model; and
storing information indicating the prediction on non-transitory computer-readable media.

12. One or more non-transitory computer-readable media storing one or more sequences of instructions that, when executed by one or more processors, cause:
based, at least in part, on a plurality of proxy models that reflect a plurality of machine learning algorithms, selecting a machine learning algorithm, of the plurality of machine learning algorithms, to fit to a training data set;
based, at least in part, on a particular proxy model, of the plurality of proxy models, that reflects the selected ML algorithm, performing feature selection on at least a portion of the training data set to produce a selected set of features of the training data set;
based, at least in part, on the selected set of features from at least a portion of the training data set, tuning a set of hyper-parameters of a machine learning model that implements the selected machine learning algorithm to produce a tuned machine learning model;
training the tuned machine learning model, using the selected set of features from at least a portion of the training data set, to produce a trained machine learning model.

13. The one or more non-transitory computer-readable media of claim 12, wherein the one or more sequences of instructions further comprise instructions that, when executed by one or more processors, cause, prior to selecting the machine learning algorithm, pre-processing the training data set.

14. The one or more non-transitory computer-readable media of claim 12, wherein each proxy model, of the plurality of proxy models, implements a different machine learning algorithm of the plurality of machine learning algorithms.

15. The one or more non-transitory computer-readable media of claim 12, wherein:
tuning the set of hyper-parameters of the machine learning model comprises:
training one or more trial machine learning models that implement the selected machine learning algorithm,
wherein each trial machine learning model, of the one or more trial machine learning models, is associated with a different set of hyperparameters that is based, at least in part, on hyperparameters of a proxy model that implements the selected machine learning algorithm.

16. The one or more non-transitory computer-readable media of claim 12, wherein the one or more sequences of instructions further comprise instructions that, when executed by one or more processors, cause processing the training data set based, at least in part, on a proxy model that implements the selected machine learning algorithm.

17. The one or more non-transitory computer-readable media of claim 12, wherein the one or more sequences of instructions further comprise instructions that, when executed by one or more processors, cause identifying a strict subset of rows, of the training data set, wherein tuning the set of hyper-parameters is performed based on the strict subset of rows.

18. The one or more non-transitory computer-readable media of claim 12, wherein the one or more sequences of instructions further comprise instructions that, when executed by one or more processors, cause identifying a strict subset of rows, of the training data set, wherein feature selection is performed based on the strict subset of rows.

19. The one or more non-transitory computer-readable media of claim 12, wherein the one or more sequences of instructions further comprise instructions that, when executed by one or more processors, cause:
initializing selection of a machine learning algorithm, of the plurality of machine learning algorithms, to fit to a second training data set;
during machine learning algorithm selection for the second training data set, determining that a time limit associated with the second training data set has expired;
responsive to determining that the time limit has expired, training a pre-determined tuned ML model, using the second training data set, to produce a trained machine learning model.

20. The one or more non-transitory computer-readable media of claim 12, wherein the one or more sequences of instructions further comprise instructions that, when executed by one or more processors, cause:
selecting a second machine learning algorithm, of the plurality of machine learning algorithms, to fit to a second training data set;
initializing performance of feature selection on the second training data set, based at least in part on the second machine learning algorithm;
wherein performance of feature selection on the second training data set comprises:
identifying a plurality of dataset samples from the second training data set, and
for each dataset sample, of the plurality of dataset samples, calculating a cross-validation score;
during performance of feature selection on the second training data set, determining that a time limit associated with the second training data set has expired;
responsive to determining that the time limit has expired:
identifying a particular dataset sample, of the plurality of dataset samples, associated with a highest cross-validation score, and
training a pre-tuned ML model, that implements the second machine learning algorithm, using the particular dataset sample, to produce a trained machine learning model.

21. The one or more non-transitory computer-readable media of claim 12, wherein the one or more sequences of instructions further comprise instructions that, when executed by one or more processors, cause:
selecting a second machine learning algorithm, of the plurality of machine learning algorithms, to fit to a second training data set;
performing feature selection on at least a portion of the second training data set, based at least in part on the second machine learning algorithm, to produce a second selected set of features of the second training data set;
initializing tuning of a second set of hyper-parameters of a second machine learning model that implements the second machine learning algorithm based, at least in part, on the second selected set of features from at least a portion of the second training data set;
wherein tuning of the second set of hyper-parameters of the second machine learning model comprises:
training a plurality of trial machine learning models that implement the second machine learning algorithm,
wherein each trial machine learning model, of the plurality of trial machine learning models, is associated with a different set of hyperparameters, and
for each trial machine learning model, of the plurality of trial machine learning models, calculating a validation score;
during tuning of the second set of hyper-parameters of the second machine learning model, determining that a time limit associated with the second training data set has expired;
responsive to determining that the time limit has expired:
identifying a combination of hyperparameters associated with one or more best validation scores, and
training an ML model, that implements the second machine learning algorithm and that is configured with the identified combination of hyperparameters, using the second selected set of features from at least a portion of the second training data set, to produce a trained machine learning model.

22. The one or more non-transitory computer-readable media of claim 12, wherein the one or more sequences of instructions further comprise instructions that, when executed by one or more processors, cause:
formulating a prediction, for a data sample not included in the training data set, using the trained machine learning model; and
storing information indicating the prediction on non-transitory computer-readable media.
